(19) United States
(12) Patent Application Publication
(10) Pub. No.: US 2025/0118483 A1
(43) Pub. Date: Apr. 10, 2025

(54) COIL DEVICE

(71) Applicant: TDK CORPORATION, Tokyo (JP)

(72) Inventors: Taichi WATANABE, Tokyo (JP); Tatsuya SATO, Tokyo (JP); Yugo ASAI, Tokyo (JP)

(73) Assignee: TDK CORPORATION, Tokyo (JP)

(21) Appl. No.: 18/901,644

(22) Filed: Sep. 30, 2024

(30) Foreign Application Priority Data
Oct. 4, 2023 (JP) 2023-173132
Sep. 12, 2024 (JP) 2024-158333

(51) Int. Cl. H01F 27/29; H01F 27/30

(52) U.S. Cl. CPC H01F 27/292; H01F 27/306

(57) ABSTRACT

A coil device includes a winding section comprised of a wound wire, a core, and a terminal fitting attached to the flange portion. The core includes a winding core portion provided with the winding section and a flange portion formed at an end of the winding core portion in its axial direction. The terminal fitting includes a main body portion disposed on an outer end surface of the flange portion, a mounting portion continuing to the main body portion and bending from the outer end surface toward a mounting surface of the flange portion, and a wire connection portion continuing to the main body portion and bending from the outer end surface toward a side surface of the flange portion. The mounting portion includes a plurality of mounting pieces arranged with at least one gap. The main body portion is adhered on the outer end surface by adhesive.

### BACKGROUND OF THE DISCLOSURE

The present invention relates to a coil device including a terminal fitting.

As shown in Patent Document 1, conventionally known is a coil device in which a terminal fitting is provided on a flange portion of a core. In the coil device of Patent Document 1, the terminal fitting includes an engagement portion that engages with the flange portion. The engagement portion includes: a mounting portion disposed on a lower surface (mounting surface) of the flange portion; a wire connection portion disposed on an upper surface (a surface opposite to the mounting surface) of the flange portion; and a main body portion disposed on an outer end surface of the flange portion. The mounting portion is connected to a land pattern of a mounting board, and the wire connection portion is connected to a leading portion of a coil. The lower surface and the upper surface of the flange portion are sandwiched between the mounting portion and the wire connection portion, and the terminal fitting can be fixed to the flange portion by the engagement portion.

In the coil device of Patent Document 1, however, when the terminal fitting is attached to the flange portion, the engagement portion may rotate around the axis of the main body portion and may be fixed to the flange portion in a direction different from a desired direction. In this case, when the coil device is mounted on the board, it may be difficult to dispose the mounting portion at a desired position on the land pattern of the board.
Patent Document 1: JP2005056934 (A)

### BRIEF SUMMARY OF THE INVENTION

The present invention is made in view of the above-mentioned circumstances. It is an object of the invention to provide a coil device having a high attachment stability of a terminal fitting to a flange portion.

To achieve the above object, a coil device according to the present invention comprises:
a winding section comprised of a wound wire;
a core including:
   a winding core portion provided with the winding section; and
   a flange portion formed at an end of the winding core portion in its axial direction; and
a terminal fitting attached to the flange portion,
wherein
the terminal fitting includes:
   a main body portion disposed on an outer end surface of the flange portion;
   a mounting portion continuing to the main body portion and bending from the outer end surface toward a mounting surface of the flange portion; and
   a wire connection portion continuing to the main body portion and bending from the outer end surface toward a side surface of the flange portion,
the mounting portion includes a plurality of mounting pieces arranged with at least one gap, and
the main body portion is adhered on the outer end surface by adhesive.

In the coil device according to the present invention, the terminal fitting includes a main body portion disposed on an outer end surface of the flange portion and a wire connection portion continuing to the main body portion and bending from the outer end surface toward a side surface of the flange portion. Thus, the main body portion and the wire connection portion function together as a stopper (rotation stopper), and the terminal fitting is less likely to rotate (pivot) in a plane parallel to the mounting surface. This fixes the terminal fitting to the flange portion in a desired orientation and makes it possible to improve the attachment stability of the terminal fitting to the flange portion. Also, the main body portion is adhered on the outer end surface by adhesive. Thus, the attachment stability of the terminal fitting to the flange portion is improved. Moreover, the positional deviation of the terminal fitting is prevented, and the terminal fitting can be effectively prevented from rotating (pivoting) in a plane parallel to the mounting surface.

Also, the terminal fitting includes a mounting portion continuing to the main body portion and bending from the outer end surface toward a mounting surface of the flange portion. Then, the mounting portion includes a plurality of mounting pieces arranged with at least one gap. Thus, the area of the mounting portion is reduced according to the area of the at least one gap. This reduces the area of the land pattern on the mounting board and makes it possible to reduce the stray capacitance of the land pattern. Also, when the coil device is mounted on the mounting board by solder, for example, a solder fillet can be formed over a wide range from the mounting pieces to the main body portion.

The wire may include a leading portion led out from the winding section, the wire connection portion may include: a wire connection piece to which the leading portion is connected; and a welding piece branching off from the wire connection piece and being bendable relative to the wire connection piece, and the welding piece may be welded to the leading portion while the leading portion is sandwiched between the welding piece and the wire connection piece. When the leading portion is interposed (sandwiched) by the welding piece, the leading portion can be fixed at a desired position of the wire connection portion. This makes it easier to weld the leading portion and makes it possible to prevent variation in the welding position of the leading portion.

The wire connection portion may include a temporary caulking piece branching off from the wire connection piece and being bendable relative to the wire connection piece, and the temporary caulking piece may be closer to the winding section than the welding piece. In this case, after the leading portion is temporarily fixed by the temporary caulking piece, the leading portion is sandwiched between the welding piece and the wire connection piece, and the welding piece can be welded to the leading portion. This further facilitates welding of the leading portion and further improves the accuracy of the welding position of the leading portion.

The wire may include a leading portion led out from the winding section, and the wire connection portion may be laser-welded to the leading portion. In this case, the wire connection portion is integrated with the leading portion, and it is possible to reduce the direct electric current resistance from the wire connection portion to the leading portion.

The flange portion may include a side notch formed on the side surface and accommodating at least a part of the wire connection portion, and the side notch may extend toward the mounting surface. In this case, when viewed from the opposite side to the mounting surface, the wire connection portion is less likely to protrude outward from the flange portion. Thus, the coil device can be downsized, and the leading portion can be prevented from being disconnected.

The flange portion may include: a first flange portion formed at one end of the winding core portion in its axial direction; and a second flange portion formed at the other end of the winding core portion in its axial direction, the terminal fitting may include: a first terminal fitting attached to the first flange portion; and a second terminal fitting attached to the second flange portion, the wire connection portion may include: a first wire connection portion provided in the first terminal fitting; and a second wire connection portion provided in the second terminal fitting, the side notch may include: a first side notch formed on a side surface of the first flange portion and accommodating at least a part of the first wire connection portion; and a second side notch formed on a side surface of the second flange portion and accommodating at least a part of the second wire connection portion, and the first side notch and the second side notch may be located on the same side in a direction perpendicular to the axial direction of the winding core portion when viewed from the axial direction. In this case, the first wire connection portion and the second wire connection portion are both arranged on the same side in a direction perpendicular to the axial direction of the winding core portion and can thus be welded on the same side. Thus, the leading portion and the wire connection portion are welded easily.

A depth of the side notch may be larger than ½ of a height of the flange portion in a direction perpendicular to the mounting surface. In this case, the arrangement space for the wire connection portion is increased, and the degree of freedom in arranging the wire connection portion is improved. Thus, it becomes easier to pull out the leading portion to a desired position of the wire connection portion.

The flange portion may include a dent formed on the mounting surface, and at least a part of the dent may be located inside the at least one gap when viewed from a direction perpendicular to the mounting surface. In this case, the mounting surface is dented between the plurality of mounting pieces (i.e., the at least one gap) so as to be away from the plurality of mounting pieces. Thus, when the plurality of mounting pieces is connected to the land pattern of the mounting board by solder, for example, the solder is less likely to adhere to the mounting surface via the at least one gap of the mounting portion. This makes it possible to prevent the core from being damaged.

At least one of the mounting pieces may be adhered on the mounting surface by adhesive. In this case, the attachment stability of the terminal fitting to the flange portion is further improved. Moreover, the positional deviation of the terminal fitting is prevented, and the terminal fitting can be effectively prevented from rotating (pivoting) in a plane parallel to the mounting surface.

The terminal fitting may include an extended main body portion disposed on the outer end surface and extending from the main body portion toward an opposite direction to the mounting portion. In this case, the adhesive area between the terminal fitting and the outer end surface of the flange portion is increased according to the area of the extended main body portion. Thus, the attachment stability of the terminal fitting to the flange portion is further improved.

The coil device according to the present invention may further comprise a plate core, and the plate core may be attached on a mounting opposition surface of the flange portion opposite to the mounting surface. When the plate core is attached to the mounting opposition surface, the inductance characteristics of the coil device are improved. In the present invention, unlike the conventional techniques, the mounting surface and the mounting opposition surface are not interposed by the terminal fitting, and the main body portion is adhered to the outer end surface of the flange portion. Thus, it is not necessary to notch the mounting opposition surface and the plate core so as to prevent interference between the terminal fitting and the plate core. This increases the contact area between the mounting opposition surface and the plate core and improves the inductance characteristics of the coil device. Moreover, the bonding strength between the mounting opposition surface and the plate core is increased.

### BRIEF DESCRIPTION OF THE SEVERAL VIEWS OF THE DRAWING

FIG. 1A is a perspective view of a coil device according to First Embodiment of the present invention;

FIG. 1B is a side view of the coil device shown in FIG. 1A as viewed from the Y-axis direction;

FIG. 1C is a side view of the coil device shown in FIG. 1A as viewed from the X-axis direction;

FIG. 1D is a plan view of the coil device shown in FIG. 1A;

FIG. 1E is a bottom view of the coil device shown in FIG. 1A;

FIG. 1F is a bottom view of a modified example of the coil device shown in FIG. 1A;

FIG. 2 is a perspective view of a core shown in FIG. 1A;

FIG. 3 is a perspective view of terminal fittings shown in FIG. 1A; and

FIG. 4 is a perspective view of a coil device according to Second Embodiment of the present invention.

### DETAILED DESCRIPTION OF THE INVENTION

Hereinafter, embodiments of the present invention are described with reference to the drawings. Note that, the illustrated contents are merely schematic and illustrative for understanding the present invention, and the appearance, dimensional ratios, etc. may be different from the actual one. Moreover, the present invention is not limited to the following embodiments.

### First Embodiment

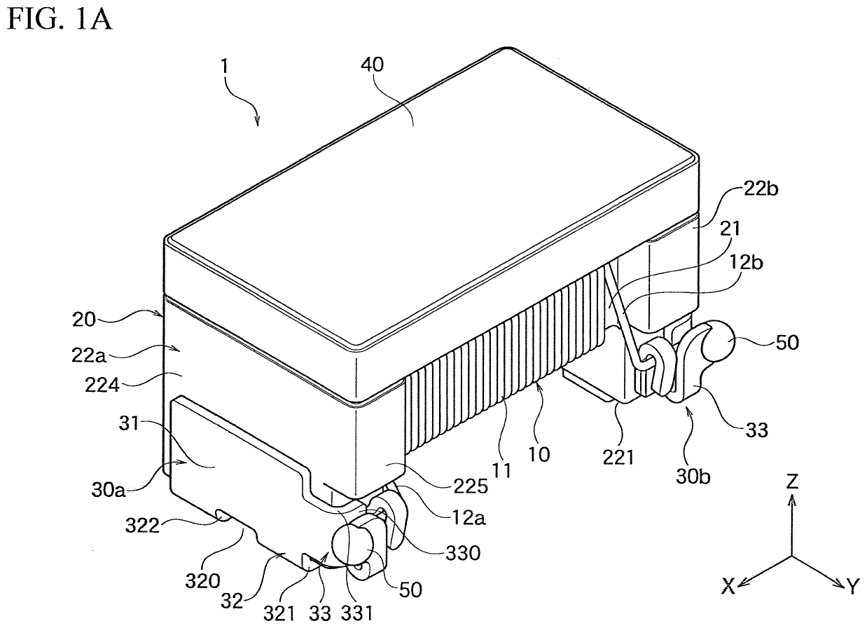

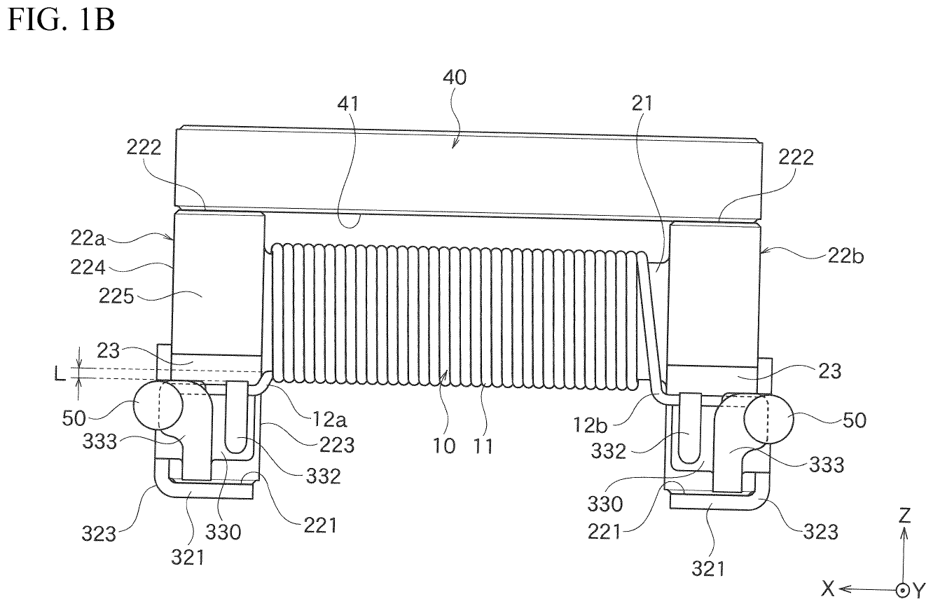

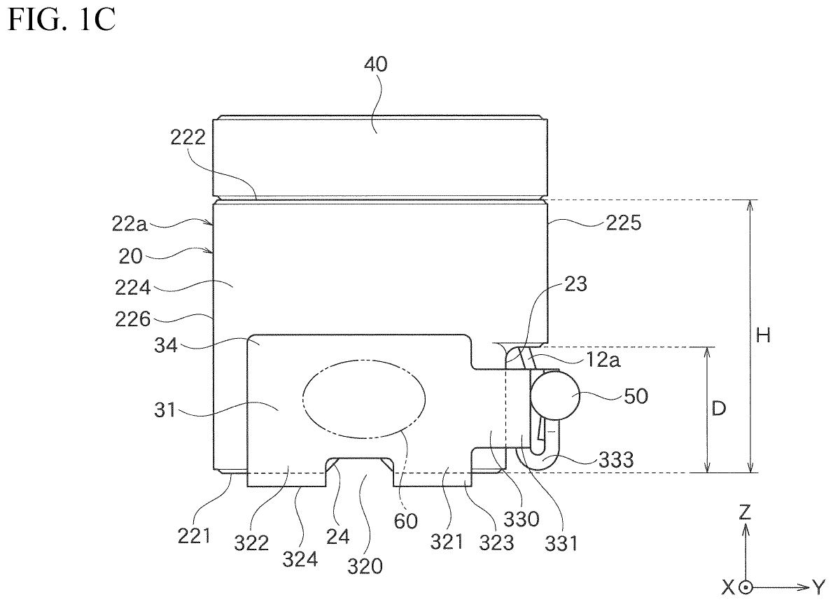

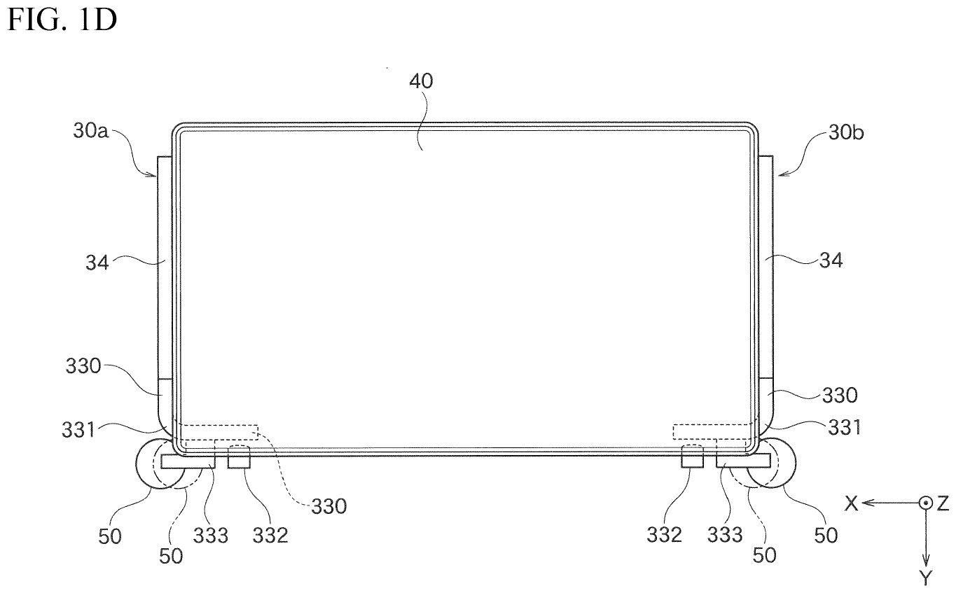

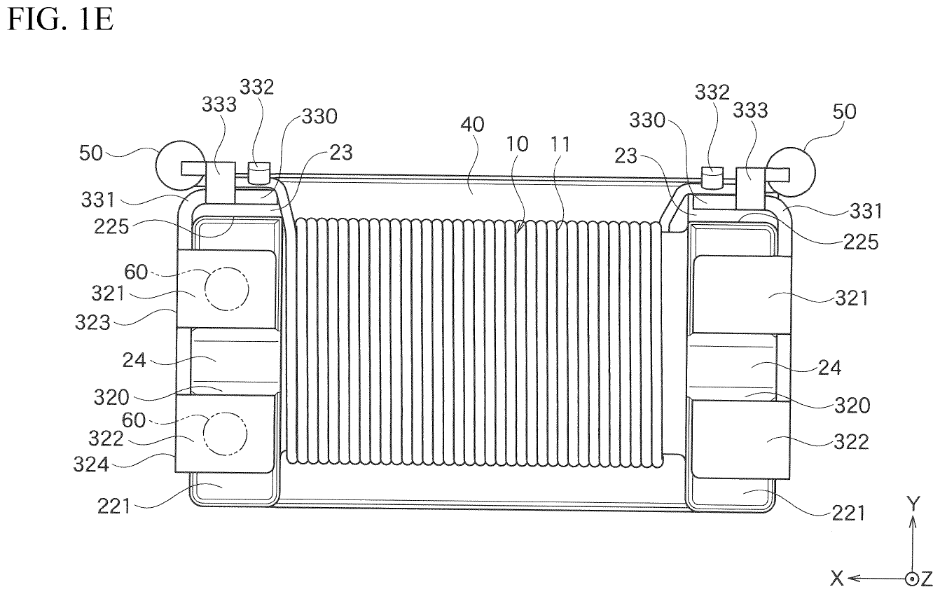

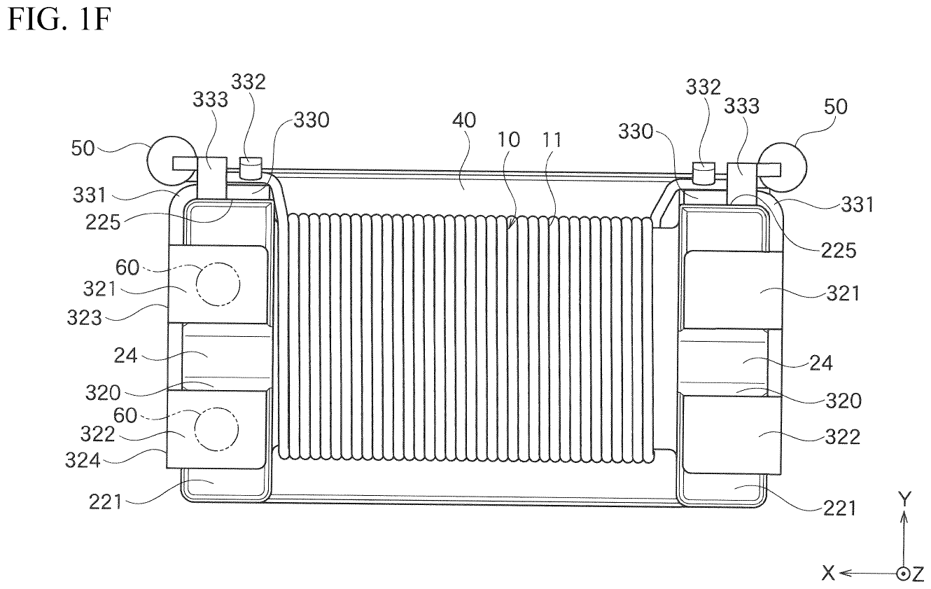

A coil device 1 according to First Embodiment of the present invention shown in FIG. 1A functions as, for example, an inductor and is mounted on the power supplies of various electrical devices. The coil device 1 includes a wire 10, a core 20, and terminal fittings 30a and 30b. In addition to these members, the coil device 1 includes a plate core 40. However, the plate core 40 is not essential.

The wire 10 includes a winding section 11 in which the wire 10 is wound in a spiral shape and leading portions 12a and 12b led out from the winding section 11. The wire 10 is an insulating-coated wire in which a conductive wire such as a round wire is covered with an insulating coating. More specifically, the wire 10 is a known winding wire such as polyamideimide copper wire (AIW), polyurethane copper wire (UEW), and polyester copper wire (PEW). The material constituting the wire 10 is not limited and is, for example, copper, copper alloy, silver, or nickel. The diameter of the wire 10 is not limited and is, for example, 10 to 300 μm. The wire 10 does not have to have an insulating coating.

The leading portion 12a is led out from one end of the winding section 11 in its winding axis direction toward the terminal fitting 30a and is connected to the terminal fitting 30a (wire connection portion 33). The leading portion 12b is led out from the other end of the winding section 11 in its winding axis direction toward the terminal fitting 30b and is connected to the terminal fitting 30b (wire connection portion 33).

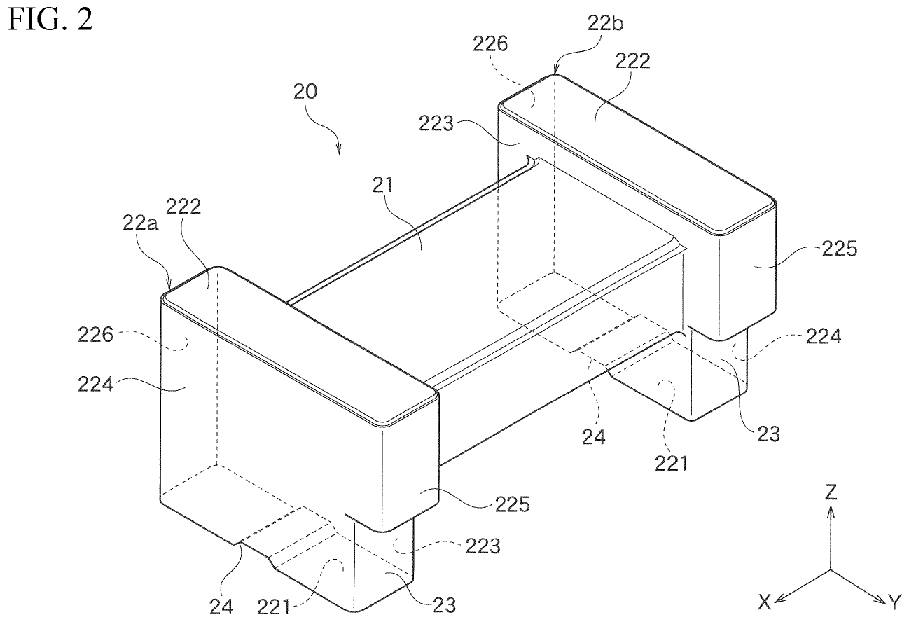

As shown in FIG. 2, the core 20 is a drum core and includes a winding core portion 21 and flange portions 22a and 22b. The material constituting the core 20 is not limited and is, for example, a magnetic metal or ferrite (Ni—Zn based ferrite, Mn—Zn based ferrite, etc.). The core 20 may be formed of a composite material containing a magnetic material and a resin.

The transverse cross-sectional shape of the winding core portion 21 is rectangular, but may be other polygonal shapes (e.g., a hexagon or an octagon), a circle, an ellipse, or the like. As shown in FIG. 1A, the winding core portion 21 is provided with the winding section 11.

As shown in FIG. 2, the flange portion 22a is formed at one end of the winding core portion 21 in its axial direction, and the flange portion 22b is formed at the other end of the winding core portion 21 in its axial direction. The shape of the flange portion 22a is the same as the shape of the flange portion 22b, but may be different from the shape of the flange portion 22b.

The flange portion 22a includes a mounting surface 221, a mounting opposition surface 222, an inner end surface 223, an outer end surface 224, a first side surface 225, and a second side surface 226. Likewise, the flange portion 22b includes a mounting surface 221, a mounting opposition surface 222, an inner end surface 223, an outer end surface 224, a first side surface 225, and a second side surface 226.

The mounting surface 221 and the mounting opposition surface 222 are opposed to each other, the inner end surface 223 and the outer end surface 224 are opposed to each other, and the first side surface 225 and the second side surface 226 are opposed to each other. Hereinafter, the X-axis is defined as an axis along the direction in which the inner end surface 223 and the outer end surface 224 are opposed to each other, the Y-axis is defined as an axis along the direction in which the first side surface 225 and the second side surface 226 are opposed to each other, and the Z-axis is defined as an axis along the direction in which the mounting surface 221 and the mounting opposition surface 222 are opposed to each other. The X-axis, the Y-axis, and the Z-axis are orthogonal to each other. The X-axis is an axis parallel to the axial direction of the winding core portion 21.

For each of the X-axis, the Y-axis, and the Z-axis, the direction toward the center of the core 20 is defined as the “inner side,” and the direction away from the center of the core 20 is defined as the “outer side.” Also, the positive side of the Z-axis is defined as the “upper side,” and the negative side of the Z-axis is defined as the “lower side.” However, the upper side in the Z-axis direction does not necessarily correspond to the upper side in the vertical direction, and the lower side in the Z-axis direction does not necessarily correspond to the lower side in the vertical direction.

The mounting surface 221 is a surface that is placed on a mounting board (not shown). A dent 24 is formed on the mounting surface 221. The dent 24 extends along the X-axis from one end to the other end of the mounting surface 221 in the X-axis direction. The inner wall of the dent 24 is an inclined surface, but may be a vertical surface. The dent 24 is located at a central part of the mounting surface 221 in the Y-axis direction. The position of the dent 24 corresponds to the position of a gap 320 (FIG. 1A) of a terminal fitting 30a or 30b described below.

The mounting opposition surfaces 222 are surfaces on which the plate core 40 (FIG. 1A) is disposed. As shown in FIG. 1B, the plate core 40 is disposed on the mounting opposition surface 222 of the flange portion 22a and the mounting opposition surface 222 of the flange portion 22b. The mounting opposition surfaces 222 are flat surfaces. However, the shapes of the mounting opposition surfaces 222 may be appropriately changed depending on the shape of a contact surface 41 of the plate core 40.

The inner end surface 223 is a surface to which an end of the winding core portion 21 in its axial direction is connected. The shape of the inner end surface 223 is the same as the shape of the outer end surface 224. As shown in FIG. 1A, the terminal fitting 30a or 30b is disposed on the mounting surface 221, the outer end surface 224, and the first side surface 225.

As shown in FIG. 2, the first side surface 225 is provided with a side notch 23. The first side surface 225 is notched inward in the Y-axis direction at the side notch 23. The side notch 23 extends toward the mounting surface 221 along the Z-axis. As shown in FIG. 1C, the upper end of the side notch 23 is located at a central part of the first side surface 225. Also, the lower end of the side notch 23 is located at the mounting surface 221. The depth D of the side notch 23 in the Z-axis direction is ½ or less of the height H of the flange portion 22a (first side surface 225) in the Z-axis direction. Thus, the area of the first side surface 225 at the side notch 23 is ½ or less of the area of the entire first side surface 225.

As shown in FIG. 2, the side notch 23 of the flange portion 22a and the side notch 23 of the flange portion 22b are located on the same side in the Y-axis direction (positive side in the Y-axis direction) as viewed from the X-axis direction. However, the side notch 23 of the flange portion 22a and the side notch 23 of the flange portion 22b may be located on different sides in the Y-axis direction as viewed from the X-axis direction.

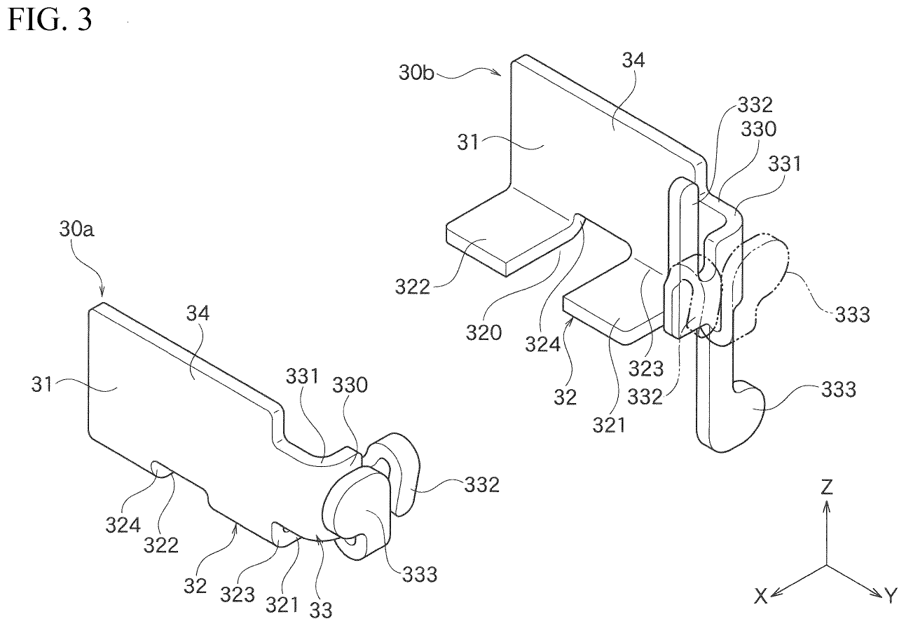

As shown in FIG. 3, each of the terminal fittings 30a and 30b includes a main body portion 31, a mounting portion 32, and a wire connection portion 33. Each of the terminal fittings 30a and 30b further includes an extended main body portion 34. However, the extended main body portion 34 is not essential. The shape of the terminal fitting 30a is mirror-symmetrical to the shape of the terminal fitting 30b.

The terminal fittings 30a and 30b are made of a conductor such as a metal. The material constituting the terminal fittings 30a and 30b is not limited and is, for example, copper, copper alloy, silver, or nickel. A plating film may be formed on the surfaces of the terminal fittings 30a and 30b. The plating film may be a single layer or a multilayer. The plating film is not limited and is, for example, Cu plating, Ni plating, Sn plating, Ni—Sn plating, Cu—Ni—Sn plating, Ni—Au plating, or Au plating. The thickness of each of the terminal fittings 30a and 30b is not limited and is, for example, 50 to 300 μm.

As shown in FIG. 1A, the terminal fitting 30a is attached to the flange portion 22a, and the terminal fitting 30b is attached to the flange portion 22b. Each main body portion 31 has a shape that is long horizontally in the Y-axis direction. The main body portion 31 is disposed on the outer end surface 224 of the flange portion 22a or 22b. For more detail, each main body portion 31 is disposed below the center of the outer end surface 224 (on the mounting surface 221 side) in the Z-axis direction.

As shown in FIG. 3, each mounting portion 32 is continuous with the main body portion 31 and is bent in an L-shape. Each mounting portion 32 includes mounting pieces 321 and 322. In the present embodiment, in terms of each of the terminal fittings 30a and 30b, the number of mounting pieces is two, but may be three or more. The mounting pieces 321 and 322 are connected to a mounting board (not shown) by solder, conductive adhesive, or the like. A fillet of solder, conductive adhesive, or the like may be formed on the main body portions 31.

The mounting pieces 321 and 322 are separated in the Y-axis direction by a gap 320. The gap 320 is formed between the mounting pieces 321 and 322 from one end to the other end in the extension direction of the mounting pieces 321 and 322.

As shown in FIG. 1A and FIG. 1B, each mounting portion 32 (mounting pieces 321 and 322) is bent (curved) from the outer end surface 224 toward the mounting surface 221. As shown in FIG. 1C, a part of each mounting piece 321 is disposed on the outer end surface 224, and a part of each mounting piece 322 is disposed on the outer end surface 224. As shown in FIG. 1B, a part of the mounting piece 321 is disposed on the mounting surface 221. Although not illustrated in detail, a part of each mounting piece 322 is disposed on the mounting surface 221. Each mounting piece 321 extends along the Z-axis on the outer end surface 224. Each mounting piece 321 extends along the X-axis on the mounting surface 221 from one end of the mounting surface 221 in the X axis direction (the end on the outer end surface 224 side) to the other side of the mounting surface 221 in the X axis direction (the inner end surface 223 side). The same applies to each mounting piece 322.

Each mounting piece 321 includes a bent portion 323. Each bent portion 323 is located between a portion of the mounting piece 321 disposed in parallel to the outer end surface 224 (a proximal end portion located on the proximal side with respect to the bent portion 323) and a portion of the mounting piece 321 disposed in parallel to the mounting surface 221 (a distal end portion located on the distal side with respect to the bent portion 323). As shown in FIG. 1B, the bent portion 323 is located at the intersection between the outer end surface 224 and the mounting surface 221. Each bent portion 323 is bent (curved) from the outer end surface 224 toward the mounting surface 221 at right angle.

As shown in FIG. 3, each mounting piece 322 includes a bent portion 324. As shown in FIG. 1C and FIG. 1E, the bent portion 324 is located between a portion of the mounting piece 322 disposed in parallel to the outer end surface 224 (a proximal end portion located on the proximal side with respect to the bent portion 324) and a portion of the mounting piece 322 disposed in parallel to the mounting surface 221 (a distal end portion located on the distal side with respect to the bent portion 324). The bent portion 324 is located at the intersection between the outer end surface 224 and the mounting surface 221. Each bent portion 324 is bent (curved) from the outer end surface 224 toward the mounting surface 221 at right angle.

At least a part of each dent 24 formed on the mounting surface 221 (in the present embodiment, the entire dent 24) is located inside the gap 320, namely, between the mounting pieces 321 and 322. In other words, the mounting pieces 321 and 322 are arranged outside each dent 24 in the Y-axis direction so as not to block the dent 24. Each mounting surface 221 is dented between the mounting pieces 321 and 322 (i.e., the gap 320) so as to be away from the mounting pieces 321 and 322. Thus, when the mounting pieces 321 and 322 are connected to the land pattern of the mounting board by solder, for example, the solder is less likely to adhere to the mounting surface 221 via the gap 320. This makes it possible to prevent the core 20 from being damaged.

The mounting portion 32 and the main body portion 31 are located on one side (the second side surface 226 side) of the center of each mounting surface 221 in the Y-axis direction. Meanwhile, the wire connection portion 33 is located on the other side (the first side surface 225 side) of the center of the mounting surface 221 in the Y-axis direction. Thus, the balance of the coil device 1 is improved between one side and the other side of the center of each mounting surface 221 in the Y-axis direction, and the mounting stability of the coil device 1 can be improved.

Each mounting piece 321 is located on the inner side of one end of the mounting surface 221 in the Y axis direction (the end on the first side surface 225 side). Thus, a part of each mounting surface 221 is exposed from the mounting portion 32 on one side in the Y axis direction. Also, each mounting piece 322 is located on the inner side of the other end of the mounting surface 221 in the Y-axis direction (the end on the second side surface 226 side). Thus, a part of each mounting surface 221 is exposed from the mounting portion 32 on the other side in the Y-axis direction.

As shown in FIG. 3, each wire connection portion 33 is continuous with the main body portion 31 and is bent (curved) in an L-shape. Each wire connection portion 33 includes a wire connection piece 330, a temporary caulking piece 332, and a welding piece 333. As shown in FIG. 1A, each wire connection portion 33 (wire connection piece 330) is bent (curved) from the outer end surface 224 toward the first side surface 225.

As shown in FIG. 1A, a part of each wire connection piece 330 is disposed on the outer end surface 224, and another part of each wire connection piece 330 is disposed on the first side surface 225. Each wire connection piece 330 extends along the Y-axis on the outer end surface 224. Each wire connection piece 330 extends along the X-axis on the first side surface 225 from one end of the first side surface 225 (the end on the outer end surface 224 side) to the other side of the first side surface 225 (the inner end surface 223 side) in the X-axis direction.

Each wire connection piece 330 includes a bent portion 331. Each bent portion 331 is located between a portion of the wire connection piece 330 disposed in parallel to the outer end surface 224 (a proximal end portion located on the proximal side with respect to the bent portion 331) and a portion of the wire connection piece 330 disposed in parallel to the first side surface 225 (a distal end portion located on the distal side with respect to the bent portion 331). Each bent portion 331 is located at the intersection between the outer end surface 224 and the first side surface 225 and is bent (curved) from the outer end surface 224 toward the first side surface 225.

As shown in FIG. 1E, a gap is formed between each wire connection piece 330 and each first side surface 225, and each wire connection piece 330 is not in contact with each first side surface 225. For example, the position of each gap 320 between the mounting pieces 321 and 322 corresponds to the position of each dent 24 of the mounting surface 221, and a gap with a predetermined width can thus be formed between the wire connection piece 330 and the first side surface 225. Note that, as shown in FIG. 1F, each wire connection piece 330 may be in contact with the first side surface 225. When each wire connection piece 330 is in contact with the first side surface 225, it is possible to prevent the bent portion 331 from being deformed. Note that, the main body portion 31 is in contact with the outer end surfaces 224 in FIG. 1E and FIG. 1F, but the main body portion 31 and the outer end surfaces 224 may not be in contact with each other.

As shown in FIG. 1B and FIG. 1C, at least a part of each wire connection portion 33 is accommodated in the side notch 23. For more detail, a part of each connection piece 330 (a part located on the distal side with respect to the bent portion 331) is accommodated in the side notch 23. A part of each caulking piece 332 and a part of each welding piece 333 are also accommodated in the side notch 23. In the present embodiment, the wire connection portion 33 of the terminal fitting 30a and the wire connection portion 33 of the terminal fitting 30b are both arranged on the same side in the Y-axis direction and can thus be welded on the same side. Thus, the leading portion 12a or 12b and the wire connection portion 33 are welded easily.

As shown in FIG. 1C, when viewed from the X-axis direction, each wire connection piece 330 does not protrude from the end of the mounting opposition surface 222 on one side in the Y-axis direction (first side surface 225 side) toward the outer side in the Y-axis direction. Thus, when viewed from the opposite side to the mounting surface 221, each wire connection piece 330 is hidden by the mounting opposition surface 222 at the position of the side notch 23. Also, as shown in FIG. 1D, when viewed from the opposite side to the mounting surface 221, each wire connection piece 330 is hidden by the plate core 40 at the position of the side notch 23. In this way, since the wire connection pieces 330 do not protrude outward from the outer edges of the plate core 40, the coil device 1 can be downsized. Also, the leading portion 12a connected to the wire connection piece 330 can be prevented from being disconnected.

As shown in FIG. 3, each welding piece 333 branches off from the wire connection piece 330 and is bendable relative to the wire connection piece 330. In FIG. 3, the state of the welding piece 333 of the terminal fitting 30b before bending is shown by solid lines, and the state of the welding piece 333 of the terminal fitting 30b after bending is shown by two-dot chain lines. Each welding piece 333 is bent upward (toward the mounting opposition surface 222 in FIG. 2) from the lower end of the wire connection piece 330. The tip of each welding piece 333 is formed wide, but the shape of each welding piece 333 is not limited. In the bent state of each welding piece 333, the tip of each welding piece 333 (a part located on the distal side with respect to the bending position) is opposed to the wire connection piece 330.

As shown in FIG. 1B, the welding piece 333 is welded while the leading portion 12a is sandwiched between the welding piece 333 and the wire connection piece 330 of the terminal fitting 30a. The leading portion 12a is located between the wire connection piece 330 and the welding piece 333 and is sandwiched between the wire connection piece 330 and the welding piece 333. Also, the welding piece 333 is welded while the leading portion 12b is sandwiched between the welding piece 333 and the wire connection piece 330 of the terminal fitting 30b. The leading portion 12b is located between the wire connection piece 330 and the welding piece 333 and is sandwiched between the wire connection piece 330 and the welding piece 333.

The leading portion 12a and the wire connection portion 33 are laser-welded. Since the leading portion 12a and the welding piece 333 and/or the wire connection portion 330 are melted, a welding ball 50 is formed in the wire connection portion 33. The leading portion 12b and the wire connection portion 33 are laser-welded. Since the leading portion 12b and the welding piece 333 and/or the wire connection portion 330 are melted, a welding ball 50 is formed in the wire connection portion 33. As an example, the welding balls 50 are formed at the tips of the welding pieces 333. In this way, the wire connection portion 33 is integrated with the leading portion 12a or 12b by the welding ball 50, and it is thus possible to reduce the direct electric current resistance from the wire connection portion 33 to the leading portion 12a or 12b.

Since the leading portion 12a or 12b is sandwiched by the welding pieces 333 and the wire connection piece 330, the leading portion 12a or 12b can be fixed at a desired position of the wire connection portion 33. This makes it easier to weld the leading portion 12a or 12b and makes it possible to prevent variation in the welding position of the leading portion 12a or 12b.

Note that, the leading portions 12a and 12b may be connected to the wire connection portion 33 (the wire connection piece 330 and/or the welding piece 333) by, for example, solder, conductive adhesive, thermocompression bonding, ultrasonic bonding, resistance brazing, ultraviolet-curing resin bonding, etc.

As shown in FIG. 3, each temporary caulking piece 332 branches off from the wire connection piece 330 and is bendable relative to the wire connection piece 330. In FIG. 3, the state of the temporary caulking piece 332 of the terminal fitting 30b before bending is shown by solid lines, and the state of the temporary caulking piece 332 of the terminal fitting 30b after bending is shown by two-dot chain lines. Each temporary caulking piece 332 is bent downward (toward the mounting surface 221 in FIG. 2) from the upper end of the wire connection piece 330. In the bent state of each temporary caulking piece 332, the tip of each temporary caulking piece 332 (the tip portion from the bending position) is opposed to the wire connection piece 330.

As shown in FIG. 1B, the wire connection piece 330 and the temporary caulking piece 332 of the terminal fitting 30a sandwich the leading portion 12a. The leading portion 12a is located between the wire connection piece 330 and the temporary caulking piece 332 and is sandwiched between the wire connection piece 330 and the temporary caulking piece 332. Also, the wire connection piece 330 and the temporary caulking piece 332 of the terminal fitting 30b sandwich the leading portion 12b. The leading portion 12b is located between the wire connection piece 330 and the temporary caulking piece 332 and is sandwiched between the wire connection piece 330 and the temporary caulking piece 332.

Each temporary caulking piece 332 and each welding piece 333 are arranged at different positions along the X-axis. Each temporary caulking piece 332 is closer to the winding section 11 than each welding piece 333. For more detail, each welding piece 333 is located on the outer end surface 224 side, whereas each temporary caulking piece 332 is located on the inner end surface 223 side. In the present embodiment, the wire connection piece 330 and the temporary caulking piece 332 can sandwich the leading portion 12a before the wire connection piece 330 and the welding piece 333 sandwich the leading portion 12a. Then, after the leading portion 12a is temporarily fixed by the temporary caulking piece 332, the leading portion 12a is sandwiched by the wire connection piece 330 and the welding piece 333, and the welding piece 333 can be welded to the leading portion 12a. This facilitates welding of the leading portion 12a and improves the accuracy of the welding position of the leading portion 12a.

The size of each welding piece 333 is larger than the size of each temporary caulking piece 332. This ensures a contact area between the leading portion 12a and the welding piece 333, and the leading portion 12a can be stably interposed by the welding piece 333. Moreover, when the leading portion 12a is welded to the welding piece 333 and/or the wire connection piece 330, a melting range is ensured, and it becomes easier to ensure conductivity between the leading portion 12a and the wire connection portion 33.

As shown in FIG. 1E, a part of each welding piece 333 is accommodated in the side notch 23, and a remaining part of each welding piece 333 is exposed from the side notch 23. However, the whole of each welding piece 333 may be accommodated in the side notch 23. Also, a part of each temporary caulking piece 332 is accommodated in the side notch 23, and a remaining part of each temporary caulking piece 332 is exposed from the side notch 23. However, the whole of each temporary caulking piece 332 may be accommodated in the side notch 23.

As shown in FIG. 1B and FIG. 1C, at least a part of each welding ball 50 is accommodated in the side notch 23. In the present embodiment, a part of each welding ball 50 is accommodated in the side notch 23, and a remaining part of each welding ball 50 is exposed from the side notch 23. However, the whole of each welding ball 50 may be accommodated in the side notch 23. This reduces the dimension of the coil device 1 in the Y-axis direction and makes it possible to downsize the coil device 1.

As shown in FIG. 1D, when viewed from the opposite side to the mounting surface 221 (FIG. 2), at least a part of each welding ball 50 is hidden by the plate core 40. As shown by the two-dot chain lines in FIG. 1D, each welding ball 50 may be formed on the further inner side of the welding piece 333 in the X-axis direction. For example, when viewed from the Z-axis direction, 30% or more of the region of each welding ball 50 may be hidden by the plate core 40. Although not illustrated in detail, in the state where the plate core 40 is not disposed in the core 20 (FIG. 2), at least a part of the welding ball 50 is hidden by the flange portion 22a or 22b (mounting opposition surface 222) when viewed from the opposite side to the mounting surface 221. In the present embodiment, a part of the welding ball 50 is hidden by the plate core 40 and the flange portion 22a, but the whole of the welding ball 50 may be hidden by the plate core 40 and the flange portion 22a. Likewise, a part of the welding ball 50 is hidden by the plate core 40 and the flange portion 22b, but the whole of the welding ball 50 may be hidden by the plate core 40 and the flange portion 22b.

This makes it possible to prevent at least a part of the welding balls 50 from being exposed to the outside of the outer edges of the flange portions 22a and 22b when viewed from the opposite side to the mounting surface 221. As a result, the dimensions of the coil device 1 are reduced, and the coil device 1 can be downsized.

As shown in FIG. 1B, the height position of the upper end of each temporary caulking piece 332 (the bent portion of each temporary caulking piece 332) is substantially equal to the height position of the lower end of the winding core portion 21. In the present embodiment, the height position of the upper end of each temporary caulking piece 332 is separated downward from the height position of the lower end of the winding core portion 21 by a distance L. However, the distance L may be 5 times or less the diameter of the wire 10 or may be 2 times or less the diameter of the wire 10. Note that, the height position of the upper end of each temporary caulking piece 332 may be equal to the height position of the lower end of the winding core portion 21. That is, L=0 may be satisfied.

This makes it possible to pull the leading portion 12a straight along the X-axis from the lower end of the winding core 21 toward the upper end of the temporary caulking piece 332. Also, the leading portion 12a can be caulked at the upper end of the temporary caulking piece 332 (near the bent portion of the temporary caulking piece 332), and the leading portion 12a can be prevented from shifting or falling off. Also, the leading portion 12a can be pulled from the lower end of the winding core 21 to the upper end of the temporary caulking piece 332 without being bent excessively, and the wire 10 can be prevented from being disconnected.

As shown in FIG. 1C, each extended main body portion 34 is disposed on the outer end surface 224 and extends from the main body portion 31 toward the opposite side to the mounting surface 221. Each extended main body portion 34 extends to a central part of the outer end surface 224 in the Z-axis direction. However, the length of each extended main body portion 34 in the Z-axis direction is not limited, and each extended main body portion 34 may extend further upward than the center of the outer end surface 224 in the Z-axis direction.

In the present embodiment, the adhesive area between the terminal fitting 30a and the outer end surface 224 can be increased according to the area of the extended main body portion 34. Thus, the attachment stability of the terminal fitting 30a to the outer end surface 224 is improved.

As shown in FIG. 1C, each main body portion 31 is adhered on the outer end surface 224 by an adhesive 60. In FIG. 1C, the adhesive 60 is indicated by a two-dot chain line, but the range of the adhesive 60 is not limited to the area indicated by the two-dot chain line. The adhesive 60 is attached to at least a part of each main body portion 31. The adhesive 60 may be attached to a part of each main body portion 31 or may be attached to the whole of each main body portion 31. The adhesive 60 may also be attached on a plurality of locations (e.g., two locations) of each main body portion 31. For example, the adhesive 60 may be attached on a first region on one side of each main body portion 31 in the Y-axis direction and a second region (a region different from the first region) on the other side of each main body portion 31 in the Y-axis direction. The adhesive 60 may also be attached on at least a part of each extended main body 34.

As shown in FIG. 1E, each mounting piece 321 is adhered on the mounting surface 221 by the adhesive 60. Also, each mounting piece 322 is adhered on the mounting surface 221 by the adhesive 60. In FIG. 1E, each adhesive 60 is indicated by a two-dot chain line, but the range of each adhesive 60 is not limited to the area indicated by the two-dot chain line. In the present embodiment, both of the mounting pieces 321 and 322 are adhered on the mounting surface 221 by the adhesive 60, but only one of the mounting pieces 321 and 322 may be adhered on the mounting surface 221 by the adhesive 60.

As shown in FIG. 1A, the plate core 40 has a rectangular parallelepiped shape (flat shape). The plate core 40 may be made of a material similar to that of the core 20 or may be made of a material different from that of the core 20. The plate core 40 is adhered to the mounting opposition surfaces 222 (FIG. 2) of the core 20 by, for example, adhesive. Since the plate core 40 is attached to the mounting opposition surfaces 222, the inductance characteristics of the coil device 1 are improved.

Next, a method of manufacturing a coil device 1 is described. First, a wire 10, a core 20, terminal fittings 30a and 30b, and a plate core 40 shown in FIG. 1A are prepared. The length of the core 20 in the X-axis direction is not limited and is, for example, 1 to 6 mm. The length of the core 20 in the Y-axis direction is not limited and is, for example, 0.5 to 4 mm. The length of the core 20 in the Z-axis direction is not limited and is, for example, 0.5 to 3 mm.

Next, the terminal fitting 30a is adhered to a flange portion 22a, and the terminal fitting 30b is adhered to a flange portion 22b. For more detail, as shown in FIG. 1C and FIG. 1E, main body portions 31 are adhered to outer end surfaces 224 by an adhesive 60. If necessary, mounting pieces 321 and 322 are adhered to mounting surfaces 221. Note that, after a winding section 11 is formed in a winding core portion 21, the terminal fitting 30a may be adhered to the flange portion 22a, and the terminal fitting 30b may be adhered to the flange portion 22b.

Next, the wire 10 is wound around the winding core portion 21 to form the winding section 11 in the winding core portion 21. Next, as shown in FIG. 1B, the wire 10 is pulled out from one end of the winding section 11 in the X-axis direction toward a wire connection portion 33 of the terminal fitting 30a. Then, a temporary caulking piece 332 is bent so as to interpose the wire 10 by the temporary caulking piece 332 and the wire connection piece 330. After that, the wire 10 is further pulled out toward the outer end surface 224 of the flange portion 22a, and a welding piece 333 is bent so as to interpose the wire 10 by the welding piece 333 and the wire connection piece 330.

Also, the wire 10 is pulled out from the other end of the winding section 11 in the X-axis direction toward the wire connection portion 33 of the terminal fitting 30b. Then, a temporary caulking piece 332 is bent so as to interpose the wire 10 by the temporary caulking piece 332 and the wire connection piece 330. After that, the wire 10 is further pulled out toward the outer end surface 224 of the flange portion 22b, and a welding piece 333 is bent so as to interpose the wire 10 by the welding piece 333 and the wire connection piece 330.

Next, the leading portion 12a is melted together with the welding piece 333 and/or the wire connection piece 330 of the terminal fitting 30a by, for example, laser welding. This forms a welding ball 50 in the wire connection portion 33 and integrates the leading portion 12a with the wire connection portion 33. Also, the leading portion 12b is melted together with the welding piece 333 and/or the wire connection piece 330 of the terminal fitting 30b. This forms a welding ball 50 in the wire connection portion 33 and integrates the leading portion 12b with the wire connection portion 33. Next, the plate core 40 is adhered to mounting opposition surfaces 222 of the flange portions 22a and 22b by adhesive. Accordingly, the coil device 1 shown in FIG. 1A can be manufactured.

As shown in FIG. 1A, in the present embodiment, the terminal fitting 30a includes a main body portion 31 disposed on the outer end surface 224 and a wire connection portion 33 continuing to the main body portion 31 and bending from the outer end surface 224 toward the first side surface 225. Thus, the main body portion 31 and the wire connection portion 33 function together as a stopper (rotation stopper), and the terminal fitting 30a is less likely to rotate (pivot) in a plane parallel to the mounting surface 221. This fixes the terminal fitting 30a to the flange portion 22a in a desired orientation and makes it possible to improve the attachment stability of the terminal fitting 30a to the flange portion 22a.

As shown in FIG. 1C, the main body portion 31 is adhered to the outer end surface 224 by the adhesive 60. Thus, the attachment stability of the terminal fitting 30a to the flange portion 22a is improved. Moreover, the positional deviation of the terminal fitting 30a is prevented, and the terminal fitting 30a can be effectively prevented from rotating (pivoting) in a plane parallel to the mounting surface 221.

As shown in FIG. 1A, the terminal fitting 30a includes a mounting portion 32 continuing to the main body portion 31 and bending from the outer end surface 224 toward the mounting surface 221. Then, the mounting portion 32 includes mounting pieces 321 and 322 arranged with a gap 320. Thus, the area of the mounting portion 32 is reduced according to the area of the gap 320. This reduces the area of the land pattern on the mounting board and makes it possible to reduce the stray capacitance of the land pattern. Also, when the coil device 1 is mounted on the mounting board by solder, for example, a solder fillet can be formed over a wide range from the mounting pieces 321 and 322 to the main body portion 31.

In the present embodiment, unlike the conventional techniques, the mounting surface 221 and the mounting opposition surface 222 are not interposed by the terminal fitting 30a, and the main body portion 31 is adhered to the outer end surface 224. Thus, it is not necessary to notch the mounting opposition surface 222 and the plate core 40 so as to prevent interference between the terminal fitting 30a and the plate core 40. This increases the contact area between the mounting opposition surface 222 and the plate core 40 and improves the inductance characteristics of the coil device 1. Moreover, the bonding strength between the mounting opposition surface 222 and the plate core 40 is increased.

As shown in FIG. 1E, the mounting pieces 321 and 322 are adhered to the mounting surface 221 by the adhesive 60. Thus, the attachment stability of the terminal fitting 30a to the flange portion 22a is further improved. Moreover, the positional deviation of the terminal fitting 30a is prevented, and the terminal fitting 30a can be effectively prevented from rotating (pivoting) in a plane parallel to the mounting surface 221.

### Second Embodiment

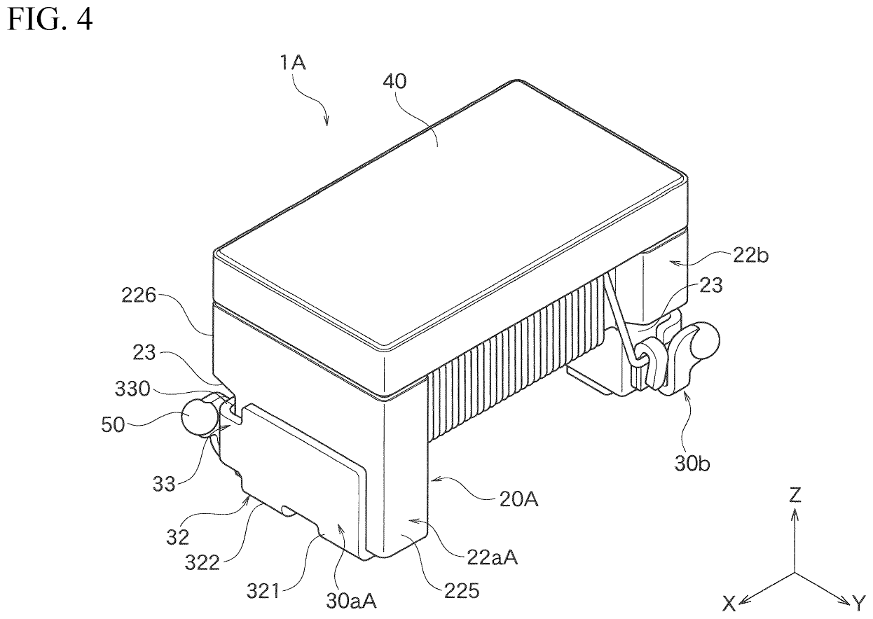

Except for the following matters, a coil device 1A of Second Embodiment shown in FIG. 4 has configurations similar to those of the coil device 1 of First Embodiment. Overlapping portions with the coil device 1 of First Embodiment are provided with the same reference numerals and are not described in detail.

The coil device 1A includes a core 20A provided with a flange portion 22aA and a terminal fitting 30aA. In the flange portion 22a of First Embodiment, the side notch 23 is formed on the first side surface 225. Meanwhile, in the flange portion 22aA of the present embodiment, the side notch 23 is formed on a second side surface 226.

In the terminal fitting 30a of First Embodiment, the wire connection portion 33 is next to the mounting piece 321. Meanwhile, in the terminal fitting 30aA of the present embodiment, the wire connection portion 33 is next to the mounting piece 322. The wire connection portion 33 (wire connection piece 330) is continuous with the main body portion 31 and is bent (curved) from the outer end face 224 toward the second side surface 226.

In the present embodiment, effects similar to those First Embodiment can also be obtained. Moreover, in the present embodiment, the side notch 23 of the flange portion 22aA and the side notch 23 of the flange portion 22b are located on different sides in the Y axis direction when viewed from the X-axis direction. Also, the wire connection portion 33 of the terminal fitting 30aA and the wire connection portion 33 of the terminal fitting 30b are located on different sides in the Y-axis direction when viewed from the X-axis direction. Thus, the balance of the coil device 1A is improved in the Y-axis direction, and the mounting stability of the coil device 1A to the mounting board is improved.

Note that, the present invention is not limited to the above-described embodiments and may be variously modified within the scope of the present invention. In each of the above-described embodiments, an example of application of the coil device 1 to an inductor is described, but the coil device 1 may be applied to other electronic components (e.g., transformers).

In each of the above-described embodiments, the plate core 40 may be omitted from the coil device 1 shown in FIG. 1A.

As shown in FIG. 1E, the mounting pieces 321 and 322 are adhered to the mounting surface 221 by the adhesive 60. However, the mounting pieces 321 and 322 do not have to be adhered to the mounting surface 221 by the adhesive 60.

As shown in FIG. 1C, the depth D of the side notch 23 in the Z-axis direction is ½ or less of the height H of the flange portion 22a (first side surface 225) in the Z-axis direction. However, the depth D of the side notch 23 in the Z-axis direction may be larger than ½ of the height H of the flange portion 22a in the Z-axis direction. In this case, the arrangement space for the wire connection portion 33 is increased, and the degree of freedom in arranging the wire connection portion 33 is improved. Thus, it becomes easier to pull out the leading portion 12a to a desired position of the wire connection portion 33.

As shown in FIG. 1E, in each of the above-described embodiments, the whole of each dent 24 is located inside the gap 320, but a part of each dent 24 may be located inside the gap 320.

### DESCRIPTION OF THE REFERENCE NUMERICAL

1, 1A . . . coil device
10 . . . wire
11 . . . winding section
12a, 12b . . . leading portion
20, 20A . . . core
21 . . . winding core portion
22a, 22b, 22aA . . . flange portion
221 . . . mounting surface
222 . . . mounting opposition surface
223 . . . inner end surface
224 . . . outer end surface
225 . . . first side surface
226 . . . second side surface
23 . . . side notch
24 . . . dent
30a, 30b, 30aA . . . terminal fitting
31 . . . main body portion
32 . . . mounting portion
320 . . . gap
321, 322 . . . mounting piece
323, 324 . . . bending portion
33 . . . wire connection portion
330 . . . wire connection piece
331 . . . bending portion
332 . . . temporary caulking piece
333 . . . melting piece
34 . . . extended main body portion
40 . . . plate core
41 . . . contact surface
50 . . . melting ball
60 . . . adhesive

What is claimed is:

1. A coil device comprising:
a winding section comprised of a wound wire;
a core including:
a winding core portion provided with the winding section; and
a flange portion formed at an end of the winding core portion in its axial direction; and
a terminal fitting attached to the flange portion,
wherein
the terminal fitting includes:
a main body portion disposed on an outer end surface of the flange portion;
a mounting portion continuing to the main body portion and bending from the outer end surface toward a mounting surface of the flange portion; and
a wire connection portion continuing to the main body portion and bending from the outer end surface toward a side surface of the flange portion,
the mounting portion includes a plurality of mounting pieces arranged with at least one gap, and
the main body portion is adhered on the outer end surface by adhesive.

2. The coil device according to claim 1, wherein
the wire includes a leading portion led out from the winding section,
the wire connection portion includes:
a wire connection piece to which the leading portion is connected; and
a welding piece branching off from the wire connection piece and being bendable relative to the wire connection piece, and
the welding piece is welded to the leading portion while the leading portion is sandwiched between the welding piece and the wire connection piece.

3. The coil device according to claim 2, wherein
the wire connection portion includes a temporary caulking piece branching off from the wire connection piece and being bendable relative to the wire connection piece, and
the temporary caulking piece is closer to the winding section than the welding piece.

4. The coil device according to claim 1, wherein
the wire includes a leading portion led out from the winding section, and
the wire connection portion is laser-welded to the leading portion.

5. The coil device according to claim 1, wherein
the flange portion includes a side notch formed on the side surface and accommodating at least a part of the wire connection portion, and
the side notch extends toward the mounting surface.

6. The coil device according to claim 5, wherein
the flange portion includes:
a first flange portion formed at one end of the winding core portion in its axial direction; and
a second flange portion formed at the other end of the winding core portion in its axial direction,
the terminal fitting includes:
a first terminal fitting attached to the first flange portion; and
a second terminal fitting attached to the second flange portion,
the wire connection portion includes:
a first wire connection portion provided in the first terminal fitting; and
a second wire connection portion provided in the second terminal fitting,
the side notch includes:
a first side notch formed on a side surface of the first flange portion and accommodating at least a part of the first wire connection portion; and
a second side notch formed on a side surface of the second flange portion and accommodating at least a part of the second wire connection portion, and
the first side notch and the second side notch are located on the same side in a direction perpendicular to the axial direction of the winding core portion when viewed from the axial direction.

7. The coil device according to claim 5, wherein a depth of the side notch is larger than ½ of a height of the flange portion in a direction perpendicular to the mounting surface.

8. The coil device according to claim 1, wherein
the flange portion includes a dent formed on the mounting surface, and
at least a part of the dent is located inside the at least one gap when viewed from a direction perpendicular to the mounting surface.

9. The coil device according to claim 1, wherein at least one of the mounting pieces is adhered on the mounting surface by adhesive.

10. The coil device according to claim 1, wherein the terminal fitting includes an extended main body portion disposed on the outer end surface and extending from the main body portion toward an opposite direction to the mounting portion.

11. The coil device according to claim 1, further comprising a plate core, wherein the plate core is attached on a mounting opposition surface of the flange portion opposite to the mounting surface.
